(19) United States
(12) Patent Application Publication
(10) Pub. No.: US 2006/0212890 A1
(43) Pub. Date: Sep. 21, 2006

(54) Optical disk apparatus

(76) Inventors: Hisahiro Miki, Chigasaki (JP); Kohei Takita, Mitaka (JP); Yoichi Narui, Matsudo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/217,265

(22) Filed: Sep. 2, 2005

(30) Foreign Application Priority Data
Mar. 18, 2005 (JP) 2005-079737

(51) Int. Cl. G11B 7/08; G11B 7/085; G11B 7/09

(52) U.S. Cl. 720/676

(57) ABSTRACT

In an optical disk apparatus, a rack member includes: a first section formed with a protrusion-shaped engaging portion which engages with the feed screw of a lead screw member; a second section coupled with the base side of an optical pickup; and a third section integrally coupled with the first section and the second section, between both of these sections, and supporting the first section in a double-end-supporting state with respect to the second section, in a plane such as a rotational plane of the lead screw member. This construction enables smooth movement of the rack member in an optical pickup feed mechanism.

### CLAIM OF PRIORITY

The present application claims priority from Japanese application serial No. P2005-079737, filed on Mar. 18, 2005, the content of which is hereby incorporated by reference into this application.

### BACKGROUND OF THE INVENTION

1. Technical Field of the Invention

The present invention relates to optical disk apparatuses, and more particularly, to construction of a rack member which is engaged with a lead screw member in the feed mechanism of an optical disk apparatus.

2. Description of the Related Art

Conventional techniques associated with the present invention include those described in, for example, Japanese Patent Laid-open Nos. 2003-208765, 11-185407, and 2003-203439. Japanese Patent Laid-open 2003-208765 describes an information-recording apparatus adapted to achieve frictional-load reduction, higher read/write quality, faster access, dimensional reduction of the apparatus, and more, by preventing the teeth of a rack section from getting over the groove of a lead screw because of moment due to the frictional force generated in the tangential direction of rotation of the lead screw. For this end, the above information-recording apparatus is of the following construction. That is, a linkage having a plate-spring property is used to support the rack section in cantilever form at the fixed section of a pickup, a compression coil spring is provided between the pickup and the rack section, and the distance from the end portion of the pickup that faces the fixed section, in the extending direction of the linkage when viewed from the axial direction of the lead screw, to the contact section between the teeth and the lead screw, is made shorter than the distance from the above end portion facing the fixed section, to the end portion facing the rack section. Also, Japanese Patent Laid-open No. 11-185407 describes the pickup feed device of a disk player or the like. This pickup feed device is constructed so that the load applied to the screw shaft of a feed screw that assigns feed force to a pickup will be kept constant, irrespective of the rotational direction of the screw shaft. For that end, a support structure composed essentially of a plate spring is attached to a base equipped with the pickup, a nut assembly is attached to the arm section of the support structure, the feed teeth of the nut assembly is meshed with the screw groove in the screw shaft, the arm section is made resiliently deflectable/deformable about its proximal supporting point longitudinally to the screw shaft, and the tips of the feed teeth of the nut assembly are made circular around a supporting point. Additionally, Japanese Patent Laid-open No. 2003-203439 describes an optical disk apparatus in which a two-piece rack structure formed up of a gear section and a fixed section is employed for optimizing constantly the meshing angle between a lead screw groove and a rack, and thus for preventing uneven wear on the gear section of the rack and reducing rack tooth skips, and other purposes. In addition, in this optical disk apparatus, the fitting section between the gear section and the fixed section is of a combined cylindrical structure, in which the gear section forming an inner cylindrical section is adapted to be rotatable in a relative fashion with respect to the fixed section an outer cylindrical section.

For the techniques described in Japanese Patent Laid-open Nos. 2003-208765 and 11-185407, however, the tooth section of the rack member which engages with the groove in the screw section of the lead screw member (hereinafter, this screw section is referred to as the feed screw) is adapted to be supported by the linkage or support structure of a cantilever state. Therefore, when the tooth section of the rack member engages with the groove in the feed screw of the lead screw member, the position of the tooth section, at the circumference of the lead screw member, changes according to the particular rotational direction of the lead screw member, and variations in the positions of the linkage or of the support structure also change. In particular in the construction where a resilient member such as a compression coil spring is used to urge the linkage by, for example, pushing it, as in the technique described in Japanese Patent Laid-open No. 2003-208765, the change in the engaging position of the tooth section with respect to the feed screw causes the point of action of the resilient member with respect to the tooth section to move according to the rotational direction of the lead screw member, and the magnitude of the force applied to the tooth section when it is pressed against the groove in the feed screw of the lead screw member will change with the above movement. For example, when high-speed access is made in a strongly pressed condition, the tooth section of the rack member is liable to disengage from the groove in the feed screw of the lead screw member, thus resulting in the so-called “tooth skipping event” in which the teeth get over the groove. Tooth skipping obstructs smooth movement of the optical pickup and deteriorates the quality of information reading from and/or writing onto the optical disk. For the technique described in Japanese Patent Laid-open No. 2003-203439, the moving accuracy of the optical pickup is liable to be affected by an event such as a disturbance based on, for example, the sliding friction occurring at the fitting section between the gear section and the fixed section.

The present invention has been made with the situations of the above conventional techniques taken into consideration, and the invention is intended to make it possible for an optical disk apparatus not only to minimize variations in an engaging position of teeth of a rack member with respect to a groove in a feed screw of a lead screw member, even when a rotational direction of the lead screw member changes, but also to maintain a approximately constant pressure load of the teeth with respect to the groove while at the same time suppressing events such as the ingress of a disturbance.

More specifically, an object of the present invention is to provide a technique for moving an optical pickup of an optical disk apparatus stably, smoothly, and with desired accuracy, even during operation such as high-speed access, by solving the foregoing problems concerned with the above conventional techniques.

### SUMMARY OF THE INVENTION

The present invention is an optical disk apparatus that solves problems associated with the conventional techniques.

More specifically, in the optical disk apparatus of the present invention, a rack member that engages with a lead screw member in a feed mechanism of an optical pickup includes: a first section in which is formed a protrusion-shaped engaging portion that engages with a feed screw of the lead screw member; a second section coupled with the base side of the optical pickup; and a third section coupled in integral form with the first and second sections, between both thereof, and supporting the first section in a double-end supporting fashion with respect to the second section, in a plane such as a rotational plane of the lead screw member (a plane approximately vertical to a central axis of lead screw member 3).

According to the present invention, an optical pickup in an optical disk apparatus can be moved stably and smoothly in approximately a radial direction of an optical disk.

### BRIEF DESCRIPTION OF THE DRAWINGS

FIG. 1 illustrates an optical disk apparatus according to an embodiment of the present invention by way of structural example;

FIG. 2 is a perspective view of an optical pickup feed mechanism in the optical disk apparatus of FIG. 1 by way of structural example;

FIG. 3 is an enlarged view of a rack member in the structural examples of FIGS. 1 and 2;

FIG. 4 is a side view showing a state in which the rack member in FIG. 3 is in engagement with a lead screw member; and

FIGS. 5A and 5B are diagrams that explain advantageous effects of the present invention.

### DETAILED DESCRIPTION OF THE PREFERRED EMBODIMENT

Preferred embodiments of the present invention will be described below using the accompanying drawings.

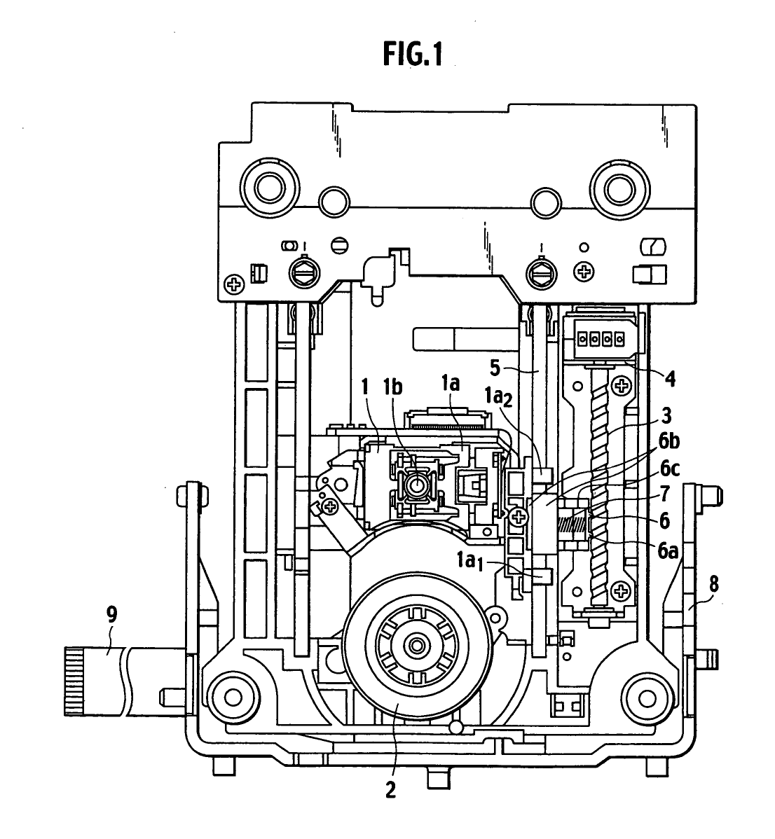

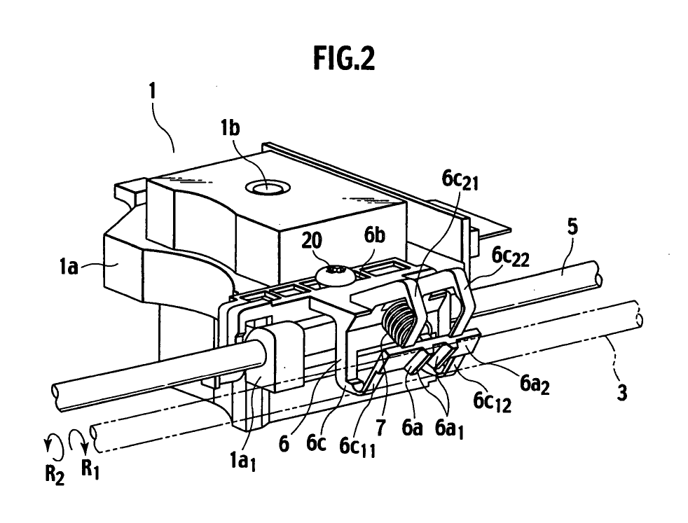

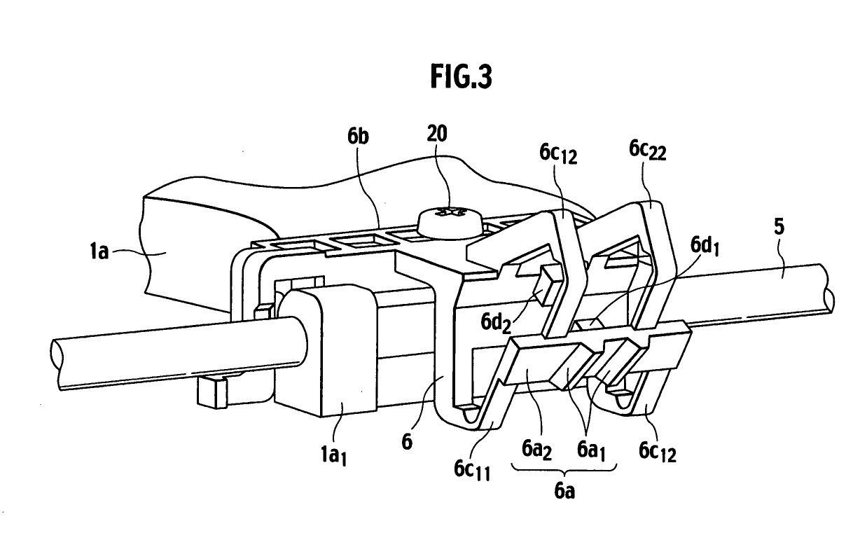

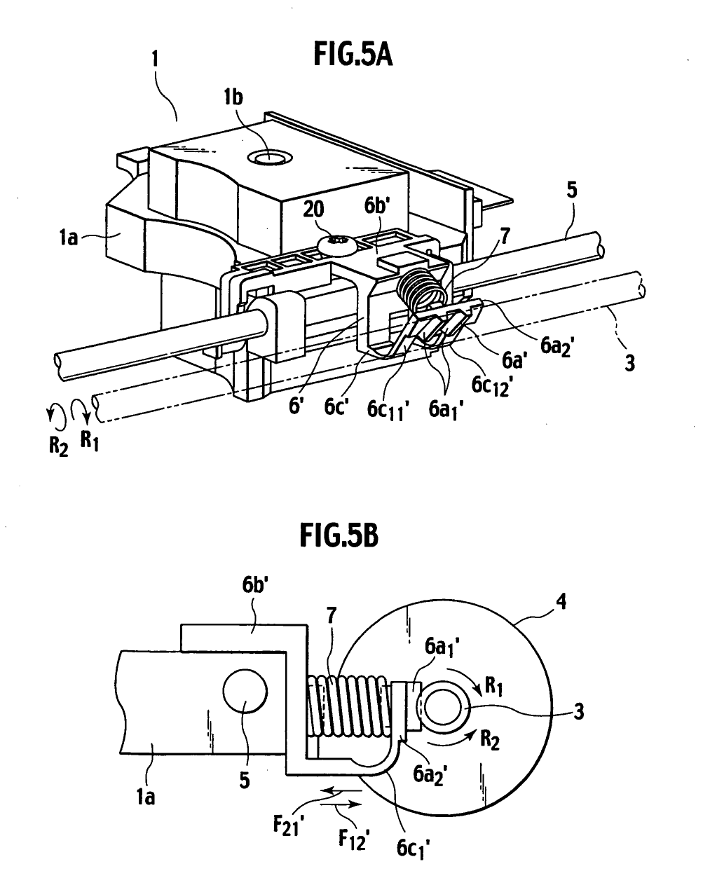

FIGS. 1 to 5A and 5B are explanatory views and diagrams of embodiments of the present invention. FIG. 1 illustrates an optical disk apparatus according to an embodiment of the present invention by way of structural example, and FIG. 2 is a perspective view of the optical pickup feed mechanism employed in the optical disk apparatus of FIG. 1 by way of structural example. FIG. 3 is an enlarged view of a rack member in the structural examples of FIGS. 1 and 2, and FIG. 4 is a side view showing a state in which the rack member in FIG. 3 is in engagement with a lead screw member. FIGS. 5A and 5B are explanatory diagrams of advantageous effects of the present invention, showing a structural example of an optical pickup feed mechanism which employs a cantilever type of rack member.

In FIG. 1, reference number 1 denotes an optical pickup for irradiating an information-recording surface of an optical disk (not shown) with laser light, receiving reflected light, and writing signals onto and reading the signals out from the information-recording surface. Reference number 1a denotes the base of the optical pickup 1 that supports the entire optical pickup, and 1b an objective lens that irradiates the recording surface of the disk with laser light and acquires reflected laser light. Reference number 2 denotes a turntable which rotates a mounted optical disk (not shown), and 3 a lead screw member which has a feed screw on the surface and rotates to move the optical pickup 1 in approximately a radial direction of the optical disk. Reference number 4 denotes a feed motor which rotationally drives the lead screw member 3, 5 a linear guide member for guiding the approximately radial movement of the optical pickup 1 toward the optical disk, 6 a double-end-supported type of rack member which has a section engaging with a groove in the feed screw on the surface of the lead screw member 3, and transmits moving force based on a rotation of the lead screw member 3, to the optical pickup 1. Reference number 6a denotes a first section (a first section of the double-end-supported rack member 6) in which, in the double-end-supported rack member 6, is formed a protrusion-shaped engaging portion that engages with the groove in the feed screw of the lead screw member 3. Reference number 6b denotes a second section (a second section of the double-end-supported rack member 6) that, also in the rack member 6, is coupled with the section of the optical pickup 1 that faces the base 1a. Reference number 6c denotes a third section (a third section of the double-end-supported rack member 6) that is coupled in integral form with the first section 6a and the second section 6b, between both thereof, and supports the first section 6a in a double-end supporting fashion with respect to the second section 6b, in a rotational plane of the lead screw member 3 (i.e., a plane approximately vertical to a central axis of the lead screw member 3) or in a plane crossing the rotational plane. Reference number 7 denotes a coil spring functioning as a resilient member to energize the rack member 6, 8 denotes a chassis, and 9 denotes a flexible substrate that has disk-wiring patterns and establishes electrical connection to outside.

The lead screw member 3 is disposed approximately parallel to the guide member 5, and the protrusion-shaped engaging portion at a front end of the first section 6a of the double-end-supported rack member 6 is in engagement with the groove in the feed screw provided on the surface of the lead screw member 3. In the present embodiment, the double-end-supported rack member 6 is constructed by plastic molding, for example, and has a structure in which the first section 6a, the second section 6b, and the third section 6c are integrally formed. Also, the third section 6c of the double-end-supported rack member 6 includes a resilient, double-end-supported arm-shaped portion, and while being urged by resilience of the coil spring 7, the third section 6c operates, by using its own resilience and the resilience of the coil spring 7, to press the protrusion-shaped engaging portion at the front end of the first section 6a against the groove in the feed screw of the lead screw member 3. The third section 6c has the above arm-shaped portion of the double-end-supported type in a plurality of places in a direction parallel to the central axis of the lead screw member 3, and forms a double-end-supporting state in the plurality of places in order to support the first section 6a. The base 1a is engaged, at two engaging positions 1a₁, 1a₂ thereof in a longitudinal direction of the guide member 5, with the guide member 5. The guide member 5, the lead screw member 3, the base 1a engaged at the two engaging positions 1a₁, 1a₂, with the guide member 5, the double-end-supported rack member 6, and the feed motor 4 constitute a feed mechanism of the optical pickup 1, namely, the optical pickup feed mechanism.

FIG. 2 is a view showing a structural example of the optical pickup feed mechanism employed in the optical disk apparatus of FIG. 1.

In FIG. 2, 6a₁ denotes a protrusion-shaped engaging portion (tooth portion) at the front end of the first section 6a in the double-end-supported rack member 6, and 6a2 denotes a structure for supporting the protrusion-shaped engaging portion (tooth portion) 6a₁ in the first section 6a of the double-end-supported rack member 6. Reference numbers 6c₁₁, 6c₁₂ denote arm-shaped portions provided below the third section 6c in the double-end-supported rack member 6 (since they are disposed below the third section 6c in the structural view of FIG. 2, these arm-shaped portions are hereinafter referred to as the lower arm-shaped portions). Reference numbers 6c₂₁, 6c₂₂ denote arm-shaped portions provided above the third section 6c in the double-end-supported rack member 6 (since they are disposed above the third section 6c in the structural view of FIG. 2, these arm-shaped portions are hereinafter referred to as the upper arm-shaped portions). Reference number 20 denotes a screw that fixes the rack member 6 to the side of the base 1a, and symbols R₁, R₂ denote rotational directions of the lead screw member 3. Meanings of other reference numbers and symbols are the same as for FIG. 1. The lower arm-shaped portions 6c₁₁, 6c₁₂ and the upper arm-shaped portions 6c₂₁, 6c₂₂ form a double-end-supported arm-shaped portion in plural places in the direction parallel to the central axis of the lead screw member 3. The lower arm-shaped portion 6c₁₁ and the upper arm-shaped portion 6c₂₁ form one counterpart to a pair of double-end-supported arm-shaped portions, and the lower arm-shaped portion 6c₁₂ and the upper arm-shaped portion 6c₂₂ form the other counterpart to that pair of double-end-supported arm-shaped portions. The lower arm-shaped portions 6c₁₁, 6c₁₂ and the upper arm-shaped portions 6c₂₁, 6c₂₂ are integrally coupled with the first section 6a and second section 6b, respectively, of the double-end-supported rack member 6, between both sections 6a and 6b. Between the first section 6a and second section 6b of the double-end-supported rack member 6, the coil spring 7 is disposed in rear of the protrusion-shaped engaging portion (tooth portion) 6a₁, at approximately an intermediate position between the upper arm-shaped portions 6c₂₁, 6c₂₂. The coil spring 7 is constructed so that after the protrusion-shaped engaging portion 6a₁ has engaged with the groove in the feed screw of the lead screw member 3, the resilience of the coil spring 7 urges the lower arm-shaped portions 6c₁₁, 6c₁₂ and the upper arm-shaped portions 6c₂₁, 6c₂₂ pushes the structure 6a₂ of the first section 6a in approximately the same direction as that of resilience of these arm-shaped portions, and thus presses the protrusion-shaped engaging portion (tooth portion) 6a₁ at the front end of the first section 6a against the groove in the feed screw of the lead screw member 3. Since, as described above, the lower arm-shaped portions 6c₁₁, 6c₁₂ and the upper arm-shaped portions 6c₂₁, 6c₂₂ constitute double-end-supported arm-shaped portions in plural places in the direction parallel to the central axis of the lead screw member 3, variations in the engaging position of the protrusion-shaped engaging portion (tooth portion) 6a₁ of the rack member 6 with respect to the feed screw of the lead screw member 3 can be reduced, regardless of whether the lead screw member 3 rotates in the direction of R₁ or in the direction of R₂. A pressure load of the tooth portion 6a₁ with respect to the groove in the feed screw can therefore be kept approximately constant.

FIG. 3 is an enlarged view of the double-end-supported rack member 6 in the construction of FIGS. 1 and 2.

In FIG. 3, 6d₁ and 6d₂ denote protruding portions that support the coil spring 7, the protrusion 6d₁ being provided at the structure 6a₂ of the first section 6a of the double-end-supported rack member 6, and the protrusion 6d₂ being provided at the second section 6b of the rack member 6. When the protrusion-shaped engaging portion 6a₁ of the first section 6a of the rack member 6 is in engagement with the groove in the feed screw of the lead screw member 3, a central axis of the coil spring 7 is made approximately linear and both ends thereof are engaged with the protrusions 6d₁, 6d₂. At the third section 6c of the rack member 6, the lower arm-shaped portions 6c₁₁, 6c₁₂ and the upper arm-shaped portions 6c₂₁, 6c₂₂ decrease in thickness halfway in a longitudinal direction of each from the second section 6b of the rack member 6, toward the first section 6a thereof, and the structure 6a₂ of the first section 6a is integrally coupled with a front end of each thin portion. The thin portions of the lower arm-shaped portions 6c₁₁, 6c₁₂ and of the upper arm-shaped portions 6c₂₁, 6c₂₂, each become resiliently displaced as a hinged portion and produce resilient force in the direction where the protrusion-shaped engaging portion (tooth portion) 6a₁ is pressed against the groove in the feed screw of the lead screw member 3.

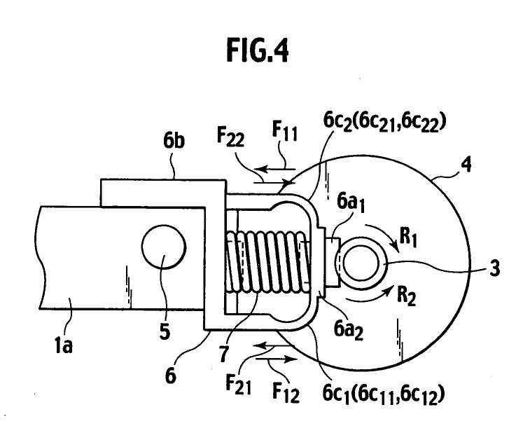

FIG. 4 is a side view showing the state in which the double-end-supported rack member 6 in FIG. 3 is in engagement with the lead screw member 3.

In FIG. 4, when the lead screw member 3 is driven by the feed motor 4 and rotates in the direction of R₁, the protrusion-shaped engaging portion 6a₁ of the first section 6a of the rack member 6 undergoes the frictional force generated during engagement with the groove in the feed screw of the lead screw member 3. At this time, an upper arm-shaped portion 6c₂ (the portions 6c₂₁, 6c₂₂ are referred to collectively as the portion 6c₂) at the third section of the rack member 6 undergoes compressive force in a direction of arrow F₁₁ and a lower arm-shaped portion 6c₁ (the portions 6c₁₁, 6c₁₂ are referred to collectively as the portion 6c₁) undergoes tensile force in a direction of arrow F₁₂. The two arm-shaped portions 6c₁, 6c₂, however, cause almost no displacement in any of respective directions, so the protrusion-shaped engaging portion 6a₁ does not change essentially in engagement position with respect to the groove in the feed screw of the lead screw member 3 and maintains approximately the same position as before the above rotation is started. Accordingly, a point of action of the coil spring 7, upon the structure 6a₂, is essentially not moved by the rotation of the lead screw member 3, and the force with which the protrusion-shaped engaging portion 6a₁ is pressed against the groove in the feed screw of the lead screw member 3 remains at much the same level as before the rotation is started. The above also applies when the lead screw member 3 rotates in the direction of R₂. That is to say, when the lead screw member 3 rotates in the direction of R₂, the protrusion-shaped engaging portion 6a₁ of the first section 6a of the rack member 6 undergoes the frictional force generated during engagement with the groove in the feed screw of the lead screw member 3. At this time, the lower arm-shaped portion 6c₁ of the third section of the rack member 6 undergoes compressive force in the direction of arrow F₂₁ and the upper arm-shaped portion 6c₂ undergoes tensile force in the direction of arrow F₂₂. However, similarly to the rotation in the direction of R₁, the two arm-shaped portions 6c₁, 6c₂ cause almost no displacement in any of the respective directions, so the protrusion-shaped engaging portion 6a₁ does not change essentially in engagement position with respect to the groove in the feed screw of the lead screw member 3 and maintains approximately the same position as before the above rotation is started. Accordingly, the point of action of the coil spring 7, upon the structure 6a₂, is essentially not moved by the rotation of the lead screw member 3, and the force with which the protrusion-shaped engaging portion 6a₁ is pressed against the groove in the feed screw of the lead screw member 3 remains at much the same level as before the rotation is started. In short, irrespective of whether the lead screw member 3 rotates in the direction of R₁ or in the direction of R₂, the protrusion-shaped engaging portion 6a₁ does not change essentially in engagement position with respect to the groove in the feed screw of the lead screw member 3, so the point of action of the coil spring 7 essentially does not change, either, and the force with which the protrusion-shaped engaging portion 6a₁ is pressed against the groove in the feed screw of the lead screw member 3 is maintained at much the same level.

FIGS. 5A and 5B are explanatory diagrams of advantageous effects of the present invention, showing a structural example of an optical pickup feed mechanism which employs a cantilever type of rack member. FIG. 5A is a view associated with FIG. 2, showing a total structure of the optical pickup feed mechanism, and FIG. 5B is a side view associated with FIG. 4, showing a state in which the cantilever type of rack member is in engagement with a lead screw member 3.

In FIG. 5, 6′ denotes the cantilever type of rack member which engages with a groove in a feed screw on the surface of the lead screw member 3, 6a′ a first section (a first section of the cantilever rack member 6′) in which is formed a protrusion-shaped engaging portion that engages with the above feed screw, 6b′ a second section (a second section of the cantilever rack member 6′) that, also in the rack member 6′, is coupled with the section of an optical pickup 1 that faces a base 1a. Reference number 6c′ denotes a third section (a third section of the cantilever rack member 6′) that is coupled in integral form with the first section 6a′ and the second section 6b′, between both thereof, and supports the first section 6a′ in a cantilever fashion with respect to the second section 6b′ in the rotational plane of the lead screw member 3. Reference number 6a₁′ denotes a protrusion-shaped engaging portion (tooth portion) provided at the first section 6a′ of the cantilever rack member 6′, and 6a₂′ denotes a structure for supporting the protrusion-shaped engaging portion (tooth portion) 6a₁′, in the first section 6a′. Reference numbers 6c₁₁′, 6c₁₂′ denote arm-shaped portions provided below the third section 6c′ in the cantilever rack member 6′ (since they are disposed below the third section 6c′ in the structural view of FIG. 5, these arm-shaped portions are hereinafter referred to as the lower arm-shaped portions). Meanings of other reference numbers and symbols are the same as for FIGS. 2 and 4.

In the construction of FIG. 5, when the lead screw member 3 is driven by a feed motor 4 and rotates in a direction of R₁, the protrusion-shaped engaging portion 6a₁′ of the first section 6a′ of the cantilever rack member 6′ undergoes the frictional force generated during engagement with the groove in the feed screw of the lead screw member 3. At this time, an arm-shaped portion 6c₁′ (the portions 6c₁₁′, 6c₁₂′ are referred to collectively as the portion 6c₁′) at the third section 6c′ of the cantilever rack member 6′ suffers upward bending displacement in the figure while undergoing tensile force in a direction of arrow F₁₂′, and an engagement position of the protrusion-shaped engaging portion 6a₁′ with respect to the groove in the feed screw of the lead screw member 3 also moves upward in the figure. Accordingly, a point of action of a coil spring 7, upon the structure 6a₂′, also moves and a force with which the protrusion-shaped engaging portion 6a₁′ is pressed against the groove in the feed screw of the lead screw member 3 is reduced below the level obtained before the rotation is started. The facts that the engagement position of the protrusion-shaped engaging portion 6a₁′ with respect to the groove in the feed screw of the lead screw member 3 moves and that the pressure load applied to the groove is reduced make the protrusion-shaped engaging portion 6a₁′ prone to skip over teeth. The above also applies when the lead screw member 3 rotates in a direction of arrow F₂₁′. That is to say, the arm-shaped portion 6c₁′ suffers downward bending displacement in the figure while undergoing compressive force in the direction of arrow F₁₂′, and the engagement position of the protrusion-shaped engaging portion 6a₁′ with respect to the groove in the feed screw of the lead screw member 3 also moves downward in the figure. Accordingly, the point of action of the coil spring 7, upon the structure 6a₂′, also moves and the force with which the protrusion-shaped engaging portion 6a₁′ is pressed against the groove in the feed screw of the lead screw member 3 is reduced below the level obtained before the rotation. The facts that the engagement position of the protrusion-shaped engaging portion 6a₁′ with respect to the groove in the feed screw of the lead screw member 3 moves and that the pressure load applied to the groove is reduced make the protrusion-shaped engaging portion 6a₁′ prone to skip over teeth.

The above drawback in the construction employing the cantilever type of rack member 6′ can be improved by adopting the construction that employs the double-end-supported rack member of the present invention, as described in FIG. 4.

According to the above embodiment, in the optical disk apparatus, while the lead screw member 3 rotates, or when the rotational direction changes, it is possible to reduce variations in the position at which the protrusion-shaped engaging portion 6a₁ of the rack member engages with the groove in the feed screw of the lead screw member 3, and thus to keep the pressure load of the protrusion-shaped engaging portion 6a₁, upon the groove, approximately constant. Consequently, even during operation such as high-speed access, the optical pickup can be moved stably and smoothly, which ensures reading and writing quality.

While the above embodiment is adapted to use a coil spring 7 to urge the double-end-supported rack member 6, this rack member may be urged using a resilient member other than the coil spring, or only the resilience of the double-end-supported rack member may be utilized without using the coil spring or other resilient members. Additionally, the optical disk apparatus of the present invention is not limited to the type shown in the above embodiment.

Without departing from its spirit or its major features, the present invention can likewise be embodied in modes other than the above form. In all respects, therefore, the above embodiment is merely an example of the invention and is not to be understood in limited fashion. The scope of the invention is specified by claims. Additionally, all modifications and changes belonging to equivalents of the claims are within the scope of the invention.

What is claimed is:

1. An optical disk apparatus that moves an optical pickup in almost a radial direction of an optical disk and conducts either writing or reading of information or both thereof, said apparatus comprising:
a guide member that engages with a base of said optical pickup in order to guide a movement of said optical pickup in the radial direction of the disk;
a lead screw member disposed almost in parallel to said guide member, wherein said lead screw member has a feed screw on the surface and rotates to transmit moving force to said optical pickup;
a rack member including:
a first section formed with a protrusion-shaped engaging portion which engages with said feed screw on said lead screw member;
a second section coupled with the base side of said optical pickup that faces said base; and
a third section integrally coupled with said first section and said second section, between both thereof, and supporting said first section in a double-end-supporting state with respect to said second section, in a rotational plane of said lead screw member or in a crossing plane with respect to the rotational plane;
wherein said rack member transmits moving force based on a rotation of said feed screw of said lead screw member, to said optical pickup via said third section; and
a feed motor that rotationally drives said lead screw member.

2. The optical disk apparatus according to claim 1, wherein said rack member further has an arm-shaped portion at said third section, said arm-shaped portion being disposed in a rotational plane, at a position different from a position in a longitudinal direction of said lead screw member.

3. The optical disk apparatus according to claim 1, wherein said rack member is adapted to resiliently displace said third section and cause said third section to utilize its resilience to push the protrusion-shaped engaging portion of said first section toward said feed screw of said lead screw member.

4. The optical disk apparatus according to claim 1, wherein said rack member is constructed such that said third section forms a double-end-supporting state in a plurality of places in a direction essentially parallel to a central axis of said lead screw member.
